(19) United States
(12) Patent Application Publication
(10) Pub. No.: US 2004/0141893 A1
(43) Pub. Date: Jul. 22, 2004

(54) Chemical reactor with enhanced heat exchange

(76) Inventor: Jerry L. Martin, Superior, CO (US)

Correspondence Address: BOULDER PATENT SERVICE INC, 1021 GAPTER ROAD, BOULDER, CO, 803032924

(21) Appl. No.: 10/348,102

(22) Filed: Jan. 21, 2003

(51) Int. Cl. B01J 8/00

(52) U.S. Cl. 422/198; 422/222; 422/211

(57) ABSTRACT

A reactor, system and method are described for performing a chemical reaction characterized by a heat of reaction. The reactor includes a first thermally conductive arrangement defining at least one catalytically active flow passage for conducting a fluid at least generally in a predetermined direction while catalytically activating the chemical reaction in a way which produces the heat of reaction. The heat of reaction conducts through the first thermally conductive arrangement in a direction at least generally parallel with the predetermined direction. A second thermally conductive arrangement is in thermal communication with the first thermally conductive arrangement and is configured for transferring the heat of reaction to an external process and for redirecting the fluid received from the first thermally conductive arrangement to a different direction. The first and second arrangements may be integrally formed using a laminated structure. A system may include a pair of thermally coupled such reactors.

### STATEMENT REGARDING FEDERALLY SPONSORED RESEARCH

This Invention was made with Government support under Contract Number DE-AC36-01GO11043 awarded by the Department of Energy. The Government has certain rights in this invention.

### BACKGROUND OF THE INVENTION

The present invention is generally related to catalytic chemical reactors and, more particularly, to a chemical reactor, reactor system and associated method encompassing a highly advantageous parallel heat and fluid flow configuration.

Chemical reactions that produce heat (exothermic reactions) and those that take up heat (endothermic reactions) form two very important classes of reactions. Some highly exothermic reactions, reactions with a large but negative heat of reaction, require heat to be removed from a system to prevent overheating. One example is the partial oxidation of ethylene to produce ethylene oxide, an important intermediate in the production of ethylene glycol. This reaction oxidizes ethylene over a catalyst to produce ethylene oxide and heat. If the reaction temperature is too high, ethylene oxide will decompose to carbon dioxide and water. In order to reduce degradation into undesired products, the reaction temperature must be held under control by removing heat produced by the partial oxidation. Conversely, endothermic reactions, those with a positive heat of reaction, do not produce heat but require heat for the reaction to proceed. Steam reforming of hydrocarbons is an endothermic reaction of considerable interest for hydrogen production as a fuel for fuel cells. Steam reforming produces hydrogen and carbon monoxide when heat is added to a catalytic reactor containing steam and hydrocarbons. Although exothermic and endothermic reactions are easy to implement, to do so with a compact and simple reactor design is challenging due to the limitations of heat transfer between the reaction and the outside of the reactor.

It is accepted in the prior art that one aspect in building compact reactors with adequate thermal exchange requires a provision for high interfacial area between the reaction stream and the reactor body. Many developers have looked towards microchannel technology, which is capable of high heat and mass transfer coefficients between a bulk reaction fluid and the catalytic heat exchange surface. Alternating channel parallel plate designs have found application for thermally coupling endothermic steam reforming with combustion in neighboring channels. Such designs have been shown to enable orders of magnitude size reduction over conventional shell-and-tube steam reformers. Enclosed parallel flow channels are typically formed by stacking plates separated by spacers, and fitting the stack with appropriate headers so that alternating channels contain the reforming reaction with exothermic combustion in the intermediate channels. Prior art examples teach that microchannel reactors exchange heat between chemically reacting fluid streams where flow is parallel to and on opposite sides of a thermally conductive separating plate.

An example of this common approach is described by U.S. Pat. No. 3,528,783. In this design, enclosed channels are formed by stacking plates separated by spacers, and the stack is fitted with appropriate headers so that alternating channels contain the reaction fluid with heat exchange fluid in the intermediate channels. The reaction channels can be filled with catalyst, and the heat exchange channels can have a structured packing to increase the heat exchange area. Another approach to increasing the surface area for reaction on each side of the separating plate is to add fins or other surface features. Indeed, this approach is adopted in an early plate-type reactor design (see U.S. Pat. No. 3,528,783). Although somewhat successful, the design still adds complexity and the alternating coupled reaction chambers continue to restrict the overall size of each chamber. A simpler approach is disclosed by Tonkovich (see U.S. Pat. No. 6,200,536 B1). All of these examples, however, share the same general flow geometry where thermal energy transfers between chemically reacting fluid streams that flow parallel to and on opposite sides of a separating plate.

The present invention recognizes that these previous reactor designs suffer from a fundamental limitation resulting from the flow configuration in which a reacting stream flows parallel to a heat transfer surface through which the majority of heat is transferred perpendicular to the direction of fluid flow. Regardless of the reaction taking place in the reaction channels, its reaction rate will vary along the flow length of that channel due to changes in concentration and temperature. Balancing the heat requirements of an endothermic reaction with heat generated by an exothermic reaction flowing parallel to and on the opposite side of a separating plate is extraordinarily difficult since the endothermic reaction is likely to have a very different dependence upon concentration and temperature than the endothermic reaction. Along the flow length of the plate that divides these reactions, the heat flux through the plate that is perpendicular to fluid flow will vary due to temperature and reaction rate differences along the flow length of the plate. Since the thermally coupled reactions are so closely coupled, neither reaction can run at a significantly different reaction rate at any point along the channel length. Thus, each reaction will exhibit a peak in reaction rate at nearly the same position within the reactor with slower reaction rates before and after this peak, which leads to the need for a long reactor channel to ensure complete conversion.

A specific example of this reaction rate problem encountered in the parallel flow arrangement is demonstrated by attempts to drive endothermic steam reforming with exothermic combustion in microchannel and alternating parallel plate reactors. A convenient way to supply heat is to couple the endothermic reaction with an exothermic combustion reaction in the heat exchange channels. Thus, the stacked reactor becomes an alternating series of endothermic and exothermic reactors separated by thin heat exchange walls. Unfortunately, the combustion reaction is difficult to control with convenient combustion catalysts and fuels, and most of the combustion occurs near the fuel inlet. This uneven combustion results in uneven heat transfer to the endothermic reaction and poor overall reactor performance.

Various approaches are seen in the prior art directed to resolving the problem of uneven combustion, typically such approaches add extraordinary complexity to the stack design so as to attempt to distribute combustion along the heat exchange surface (as examples, see U.S. Pat. Nos. 5,015,444 and 5,180,561). The key feature of these designs is to add a fuel dispersion channel between each unit stack consisting of combustor-reformer-combustor. The plate separating the combustor and dispersion channel is a porous plate that is intended to facilitate even distribution of fuel across the entire combustion chamber. Even still, the combustion reaction is somewhat uneven because air is introduced to the combustion channels at one end rather than evenly like the fuel. Moreover, the increased complexity of this design requires the addition of multiple plates and internal feed channels to keep air out of the dispersion channels, which adds to system mass, construction costs, and system limitations.

A further disadvantage of the parallel flow reactor geometry is that the operating temperatures of the two reactions must be similar since the separate streams are separated only by the thin separating and heat transfer plate. For example, as recognized by the present invention, maintaining the temperature of methanol steam reforming at or below 300° C. is very difficult when heat is supplied by catalytic combustion, which typically runs above 500° C. Thermally matching the reactions is still further complicated by the inherent temperature gradients that are present along the flow length of the reaction channel. It is submitted that any solution directed to resolving this thermal matching problem in a parallel flow configuration will add significant complexity or mass to the system.

Further disadvantages of the parallel flow reactor geometry include the complicated headering necessary to distribute and separate flows through alternating channels and the difficulty of independently sizing the exothermic and endothermic sides of the coupled reactor. Since these prior art reactors comprise an alternating stack of reformer and combustor reactor channels, it is difficult to match the size and requirements for each side. In essence, the coupled reactors cannot be separated since the alternating channel design precludes separation of reformer and combustor.

As will be further described, the present invention recognizes that the shortcomings of prior art microchannel reactors are fundamentally related to the direct coupling of reforming and combustion reactions by performing them on opposite sides of the separating plate in a parallel flow configuration. Many of the preceding reactor examples pursue a combination of microchannel reactor technology with heat exchange in a direction perpendicular to the reacting fluid flow to achieve a compact catalytic reactor. It is recognized by the present invention that this combination places several demands on the design, requiring additional complexity or mass for effective operation. Therefore, a new reactor design that maintains effective operation in a compact device constructed with less complexity would be greatly beneficial. Such a design has, until now, remained elusive.

The present invention is submitted to resolve the foregoing problems and concerns while providing still further advantages.

### SUMMARY OF THE INVENTION

There is described herein, an assembly and method for use in performing a chemical reaction that is characterized by a heat of reaction. In one aspect of the present invention, the assembly includes first thermally conductive means defining at least one catalytically active flow passage for conducting a fluid at least generally in a predetermined direction while catalytically activating the chemical reaction with the fluid in a way which produces the heat of reaction. The heat of reaction conducts primarily through the first thermally conductive means in a direction at least generally parallel with the predetermined direction. Second thermally conductive means is in thermal communication with the first thermally conductive means and is configured for transferring the heat of reaction to an external process and for redirecting the fluid received from the first thermally conductive means to a different direction as compared to the predetermined direction.

In another aspect of the present invention, the assembly is formed as an overall laminated structure of alternating first and second plate members.

In still another aspect of the present invention, a compact chemical reactor includes thermally conductive means including a first portion for defining one or more catalytically active channels through which a reaction fluid flows and which cooperate to at least generally define a flow direction of the reaction fluid therethrough, thereby producing a heat of reaction. A second portion of the thermally conductive means defines at least one exit channel in fluid communication with the catalytically active channels and further defines a heat transfer surface, in thermal communication with the first portion, defining the catalytically active channels, in a way which serves to redirect flow of the reaction fluid from the catalytically active channels into the exit channel such that a direction in which the heat of reaction conducts through the first portion is at least generally parallel to the flow direction and a substantial portion of the heat of reaction passes through the heat transfer surface.

In yet another aspect of the present invention, a system and method are described for transferring a heat of reaction between first and second processes that are performed within the system. The system includes first thermally conductive means for executing the first process and configured for receiving a first flow of a first fluid through a first passage arrangement such that an overall flow of the first fluid includes a first directional orientation that is directed toward a first internal surface of a first thermal interface member, formed by the first thermally conductive means. The first thermally conductive means is further configured for directing the first fluid outwardly therefrom and away from the first directional orientation across the first internal surface. Second thermally conductive means is provided for executing the second process and is configured for receiving a second flow of a second fluid through a second passage arrangement such that the overall flow of the second fluid includes a second directional orientation that is directed toward a second internal surface of a second thermal interface member, formed by the second thermally conductive means. The second thermally conductive means is further configured for directing the second fluid away from the second directional orientation across the second internal surface. Further, the second thermal interface member is arranged in thermal communication with the first thermal interface member such that the first and second processes are thermally coupled between the first and second thermal interface members. At least one of the first and second thermally conductive means includes a configuration for catalytically activating at least one of the first passage arrangement and the second passage arrangement so as to produce the heat of reaction for thermal coupling through the first and second thermal interface members.

In a continuing aspect of the present invention, a system and method are described for providing a heat of reaction between first and second processes that are performed within the system. The system includes first thermally conductive means for executing the first process and is configured for receiving a first flow of a first fluid through a first passage arrangement to define a first directional flow orientation along which a first temperature gradient is present such that the first flow is directed toward a first internal surface of a first thermal interface member, formed by the first thermally conductive means, and, thereafter, is directed out of the first thermally conductive means. Second thermally conductive means is provided for executing the second process and is configured for receiving a second flow of a second fluid through a second passage arrangement to define a second directional flow orientation along which a second temperature gradient is present such that the second flow is directed toward a second internal surface of a second thermal interface member, formed by the second thermally conductive means, and, thereafter, is directed out of the second thermally conductive means. The second thermal interface member is thermally coupled to the first thermal interface member. At least one of the first and second thermally conductive means includes a configuration for catalytically activating at least one of the first and second processes so as to produce the heat of reaction for thermal coupling through the first and second thermal interface members.

### BRIEF DESCRIPTION OF THE DRAWINGS

The present invention may be understood by reference to the following detailed description taken in conjunction with the drawings briefly described below.

FIG. 1 is a diagrammatic view, in perspective, of one embodiment of the highly advantageous chemical reactor of the present invention, shown here to illustrate details of its structure.

FIG. 2 is a diagrammatic, partially exploded view of the chemical reactor of FIG. 1, shown here to illustrate further details of its structure.

FIG. 3 is a diagrammatic, partially exploded view, in perspective, of another embodiment of the chemical reactor of the present invention, shown here to illustrate details of its structure including the use of a porous, channel defining material.

FIG. 4 is a diagrammatic view, in perspective, of still another embodiment of the chemical reactor of the present invention, shown here to illustrate details of its structure including the use of a coiled channel defining strip.

FIGS. 5a and 5b are diagrammatic side views of the chemical reactor of the present invention supporting an exothermic reaction and an endothermic reaction, respectively, shown here to illustrate a relationship between heat flow and reactant flow in each reactor.

FIG. 6 is a diagrammatic, partially exploded, perspective view of a high advantageous reactor system, produced in accordance with the present invention, and shown here to illustrate details of its structure.

### DETAILED DESCRIPTION OF THE INVENTION

Turning now to the figures, wherein like reference numbers are used to refer to like components, attention is immediately directed to FIG. 1 which illustrates one implementation of the chemical reactor of the present invention, produced in accordance with the present invention, and generally indicated by the reference numeral 10. It is noted that the various figures are not to scale for purposes of enhancing the reader's understanding. Moreover, terminology such as upper, lower, vertical and horizontal is in no way intended as limiting with respect to device orientation or operation, and is used only for descriptive purposes.

Reactor 10 comprises a laminated plate structure having an overall peripheral configuration, on one surface thereof, which defines an arrangement of inlet ports 12, each of which includes an elongated, rectangular mouth that leads into one of a series of spaced apart, generally parallel passages that are designated using a series of arrows 14, for purposes of clarity. Arrows 14 may also be referred to as generally designating reactants flowing into these passages. On at least one surface of the peripheral configuration, which is at least generally normal to the inlet port defining surface, an arrangement of exhaust or outlet ports 16 is formed, emerging from a corresponding series of exhaust channels 18, designated by a second plurality of arrows. For purposes of the present example, it is assumed that an identical exhaust port configuration is also present opposite the illustrated exhaust port configuration, as denoted by one exhaust arrow 20 which points rearward from reactor 10, as will be further described. It is important to understand, as will be further brought to light, that channels 18 are defined transverse or normal to passages 14 such that a fluid flow entering passages 14 passes into exhaust channels 18 and is then redirected out of the direction of fluid flow that is present within the passages. It is noted that the present invention considers the term “fluid” to encompass a gas, a liquid or any combination thereof. Accordingly, any embodiment of the chemical reactor of the present invention readily accommodates a phase change.

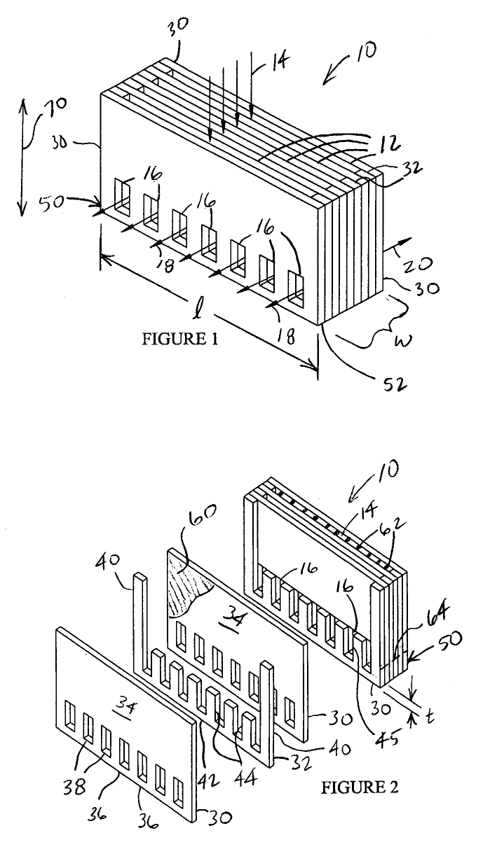

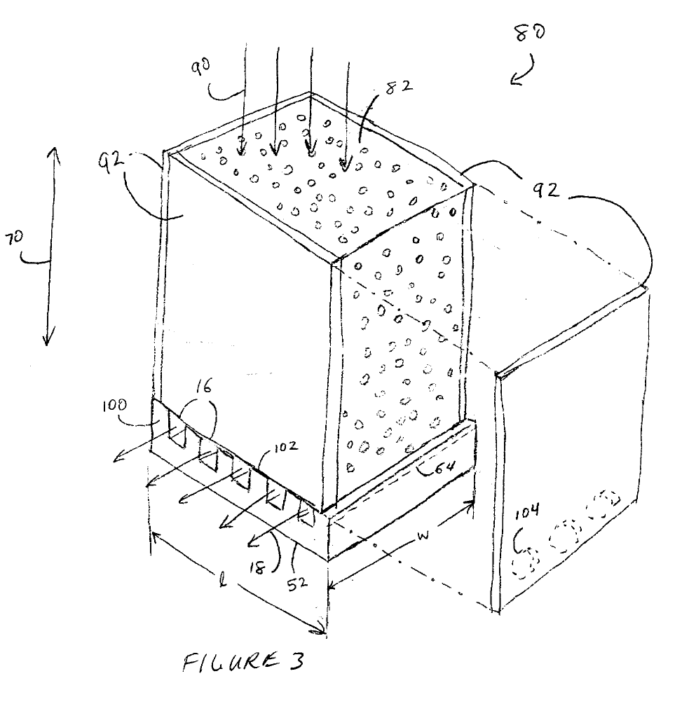

Referring to FIG. 2 in conjunction with FIG. 1, the former figure is an exploded perspective view of reactor 10 which further illustrates details of its highly advantageous structure. Specifically, reactor 10 is formed using an alternating series of first and second plate members, selected ones of which are indicated by the reference numbers 30 and 32, respectively. Each of the plates is integrally formed and stacked in thermal communication. The plates may be formed using any suitable material having high thermal conductivity and stability at a contemplated reaction temperature, for example, metals and high conductivity ceramics are well-suited. The plates may be formed in any suitable manner such as, for example, by stamping, machining or photoetching. Thermal attachment or bonding of the plates to one another may be accomplished in any suitable manner in order to contain a reaction fluid based, at least in part, on the specific material or materials from which the plates are formed including, but not limited to brazing, diffusion bonding, sintering, or bolt pressure. It is noted that the present invention contemplates fluids as being gaseous, liquid or a combination thereof.

Continuing to refer to FIGS. 1 and 2, characteristics of each first plate 30, one of which comprises the end plate on each opposing end of the exemplary reactor, include a passage separation wall 34 and a first thermal header portion 36. A series of spaced apart exhaust channel apertures 38, several of which are indicated, are defined between passage separation wall 34 and first thermal header portion 36.

Each second plate member 32 includes an opposing pair of projecting spacer arms 40 that extend from a second thermal header portion 42. The latter further supports a series of separation tabs such that each separation tab 44 (two of which are indicated) projects from second thermal header portion 42 in a way which defines an exhaust channel section 45 (one of which is indicated) between adjacent ones of the separation tabs, leading into one of exhaust channels 16. Additional exhaust channel sections are defined between each spacer arm 40 and an adjacent one of separation tabs 44. In this regard, it should be appreciated that each second plate member 32 is captured between a pair of first plate members 30, in the overall laminated structure, to cooperatively define passages 14 between confronting passage separation walls 34 of the first plate members. Exhaust channels 18 are cooperatively defined, in the laminated structure of the first and second plate members, since the assembly process aligns exhaust channel apertures 38 of the first plate members with exhaust channel sections 45 of the second plate members. Passages 14 are therefore in fluid communication with exhaust channels 18. It is to be understood that separation tabs 44 are not required, since exhaust channels 18 may be adequately defined by aligned exhaust apertures 38. Separation tabs 44 may be advantageous, however, for purposes of maintaining the spaced apart relationship between confronting pairs of first plate members 30, as well as for reasons yet to be described. Moreover, only one surface of reactor 10 is required to emit exhaust via apertures 38. Accordingly, the opposing ends (not shown) of the exhaust channels may be sealed using an adapted one (not shown) of first plate members 30 having no apertures defined therein.

Still referring to FIGS. 1 and 2, the laminated structure of the present invention causes first base portions 36 of the first plate members and second base portions 42 of the second plate members to cooperatively form a laminated thermal base 50 having a thickness t (FIG. 2), a width w (FIG. 1) and a length 1 (FIG. 1). A lowermost surface comprises a thermal interface 52 of reactor 10. Separation tabs 44 are further advantageous for increasing thermal conductance between thermal interface surface 52 and passage separation walls 34. It should be appreciated that reactor 10, including thermal interface surface 52 (FIG. 1), is readily and advantageously scalable in order to suit an intended application or to support a particular chemical reaction based, at least in part, on its heat of reaction. Exemplary adjustments which may be utilized include adjustment of a reaction length of passages 14, the number of passages 14, length and width of thermal interface 52 (in view, for example, of a requisite thermal flux per unit area) and, thereby, the overall reactor, as well as the spacing of the separation walls 34. Essentially, there are an unlimited number of ways in which reactor 10 can be tailored to suit a particular reaction by adjusting parameters including the surface area of the reactor, thermal conductance, and hydraulic diameter of the passages; unmentioned adjustments are considered as being within the skill of one having ordinary skill in the art in view of this overall disclosure. Passages 14 may be catalytically activated in any suitable manner, as will be described immediately hereinafter.

In a first catalyst implementation of reactor 10, the material from which at least first plate members 30 is formed may act catalytically for a contemplated chemical reaction. For example, platinum metal plates could be used for catalytic combustion of hydrocarbons. Of course, second plate members 32 may likewise be fabricated from a catalytically active material.

In a second catalyst implementation of reactor 10, a catalyst 60 is diagrammatically shown, partially applied to one separation wall 34 in FIG. 2 to form a catalytic surface. In this implementation, catalyst may be applied to passage 14 defining surfaces before or after the bonding of the first and second plate members to one another. Catalyst may be directly applied, or a high surface area washcoat may be applied to passage 14 defining surfaces as a catalyst support. Appropriate catalyst formulations depend on the type of reaction to be used in the reactor. For instance, platinum metal is a suitable catalyst for an exothermic hydrogen combustion reaction. Platinum metal can be deposited by well-established techniques that are currently available including, but not limited to wet impregnation and oxidation of platinum salts, chemical vapor deposition and reduction of organometallic precursors, or by any other suitable technique yet to be developed. An example of a catalyst for an endothermic reaction is copper/zinc for steam reforming of methanol. This type of catalyst can be deposited within passages 14 by methods similar to platinum deposition or by sol-gel washcoat methods. Moreover, selected surfaces of plate members 30 and 32 can be coated with catalyst prior to assembly of the stack. For example, a thin 50% aluminum 50% copper/zinc metal foil can be bonded to selected surfaces of the plate members (particularly, the major surfaces of first plate member 30) prior to assembly. After assembly, the aluminum metal can be removed by leaching in a caustic to make porous Raney type copper/zinc catalyst.

In a third catalyst implementation of reactor 10, any suitable catalytic material 62 may be captured within passages 14 (diagrammatically shown for one passage 14 in FIG. 2) such as, for example, pelletized materials, porous material in a sheet form that is sized to fit passage 14, fiber, and gauze inserts or wire mesh structures.

With reference to FIG. 2, reactor 10 may be thought of as two thermal assemblies that are generally separated by a dashed line 64 shown at one side of reactor 10. In the present example, the assemblies are integrally formed by distinct portions of each of first plate member 30 and second plate member 32, although such integral formation is not a requirement. The first assembly comprises a first thermally conductive arrangement (above dashed line 64) which defines catalytically active passages 14, while a second assembly comprises a second thermally conductive arrangement (below dashed line 64) defining a base plate/thermal interface in a confronting relationship with outlets of passages 14 so as to cause the flow of the reaction fluid from passages 14 to be redirected across a base surface in directions transverse or normal to the fluid flow in the passages and, thereafter, through exit channels 18 leading out of the reactor.

Referring to FIG. 1, during operation of reactor 10, a reaction fluid flows into the inlet of each catalytically active passage 14 using an appropriate header, which may consist of a plenum sealed to the perimeter of the inlet ports 12 by a gasket (not shown). A heat of reaction is therefore generated as the fluid flows through each passage 14 toward thermal header 50. It is important to understand that this heat of reaction can be either endothermic or exothermic, and that heat may flow either into or out of the reacting fluid, and in general may flow both into and out of the fluid at different locations within the structure. As the fluid flows through the passages 14, heat is transferred between the chemical reaction and plate members 30 and 32 and is conducted along the plates in a direction that is generally aligned or parallel with the reactant fluid flow in passages 14; that is, at least generally in directions that are parallel to a double headed arrow 70. At the same time, a thermal gradient is defined in reactor 10 along the direction of arrow 70. Further, heat is transferred through the thermal interface 52 along paths that are at least generally parallel to arrow 70. The specific direction of heat flow across thermal interface 52 is defined, of course, by whether the chemical reaction absorbs or releases heat, consistent with its heat of reaction. For the case of performing an endothermic reaction within reactor 10, heat may be supplied to the reactor by thermal conduction from a hot body attached to thermal interface surface 52 or by applying flame, electrically generated heat, heated gases, or thermal radiation to thermal interface surface 52. When an exothermic reaction is performed within reactor 10, heat may be removed from the reactor through thermal interface surface 52 by thermal radiation, by thermal conduction to a cold body, or by applying cold gases or spray cooling.

As will be described in detail immediately below, the general configuration of reactor 10 has been empirically verified by Applicants to exhibit performance advantages that far exceed what one of ordinary skill in the art would reasonably expect. Moreover, Applicants are unaware of any reactor configuration in the prior art, as a whole, that incorporates the highly advantageous parallel heat and fluid flow geometry of the present invention. It is submitted that these remarkable advantages arise primarily as a result of aligning the reacting fluid flow with the heat flow in the passage walls and providing a means of transferring this heat into or out of the reactor.

Having described one highly advantageous embodiment of the present invention, descriptions of a number of additional highly advantageous embodiments will now be provided. Accordingly, descriptions of like components and functionality present in these additional embodiments will not be repeated for purposes of brevity and the descriptions will be limited primarily to ways in which these additional embodiments differ from reactor 10. These additional embodiments share all of the advantages of the first embodiment and may provide still further advantages.

FIG. 3 shows a partially exploded view of a reactor, generally indicated by the reference number 80, comprising an alternate embodiment of the present invention. In this embodiment, a porous material 82 forms the reaction and heat exchange channels and replicates the function of passage separation wall 34 in FIG. 1. Porous material 82 may be a metal or thermally conductive ceramic foam, a sintered or otherwise bonded thermally conductive particulate, a bundle of wire or tubes, or any structure that allows fluid flow through open passages and heat flow through the solid portions of the porous structure. Moreover, the porous material may itself catalytically reactive or may be treated with a catalytic reactant in any suitable manner. For example, porous platinum material can be used to support catalytic combustion and conduction of the heat of reaction, or the porous material can be made from copper to conduct the heat of reaction and the copper can be coated with catalyst such as platinum for catalytic combustion or nickel for steam reforming. The reacting fluid flow entering porous material 82 in a direction generally defined by arrows 90 flows through the open structure defined by porous material 82. Containment plates 92 are bonded to the sides of the porous material 82 as shown in FIG. 3 to direct the flow of fluids between the open feed side of porous material 82 and exhaust or outlet ports 16 and leave the reactor through exhaust channels generally designated by arrow 18. Containment plates 92 can be applied to porous material 82 by diffusion bonding, brazing, adhesive bonding, bolting pressure, or any other appropriate method that attaches the containment plates 92. Note that the containment plates can be replaced by any suitable expedient to close the pores at the outer surfaces of porous material 82 such as, for example, by filling the external surface pores with a non-porous material. Exhaust channels 18 are defined by grooves cut or otherwise provided in the base plate/thermal interface 100 along the width w (FIG. 3). Base plate/thermal interface 100 is in thermal communication with porous material 82 where base plate lands 102 (defined by base plate 100) are in contact with the porous material, and the bond between base plate lands 102 and porous material 82 may be formed by diffusion bonding, brazing, bolting pressure or other method that provides appropriate thermal contact. Fluid exhaust ports can be provided by alternate arrangements when grooves are not provided in base plate 100. For instance, limiting the length of at least one containment plate 92 so that porous material 82 is exposed and open near the bond between base plate 100 and porous material 82 provides an opening for exhaust gases to leave the system. An alternate provision for the exhaust ports is provided by supplying at least one exhaust channel aperture indicated by a series of dashed circles 104 in at least one containment plate 92. Grooves can be cut into the porous material where porous material 82 is joined to the base plate 100 in order to reduce pressure drop to exit ports 104.

As previously discussed for reactor 10 in FIG. 1, reactor 80 in FIG. 3 is readily and advantageously scalable. Exemplary adjustments which may be utilized include adjustment of a flow length of porous material 82, the pore volume and pore size of porous material 82, length and width of thermal interface 52 (in view, for example, of a requisite thermal flux per unit area) and, thereby, the overall reactor. Intrinsic properties of porous material 82 can be chosen to provide flow channels with varying degrees of surface area (wetted perimeter). Essentially, there are an unlimited number of ways in which reactor 80 can be tailored to suit a particular reaction by adjusting parameters including the surface area of the reactor, thermal conductance, and hydraulic diameter of the passages; unmentioned adjustments are considered as being within the skill of one having ordinary skill in the art in view of this overall disclosure.

In operation, reactor 80 of FIG. 3 retains the same functionality of reactor 10 in FIG. 1, except that on a microscopic level, heat and fluid flow is not required to flow generally parallel to arrow 70, but throughout reactor 80 the average fluid and heat flow direction is generally parallel to arrow 70. In this regard, it is important to understand that a substantial portion of heat flow occurs along thermal paths that are defined within the thermally conductive porous material, each of these paths being in direct thermal communication with base plate 100. That is, these thermal paths comprise the pore defining material itself or the “solid structure” of the porous material. One potential advantage of reactor 80 in FIG. 3 resides in the fact that porous material 82 can provide higher surface area per unit volume than the parallel plate configuration shown in FIG. 1. Another potential advantage associated with using porous material 82 is seen in construction of the present invention, since such porous materials can be less expensive to fabricate than high surface area laminated structures.

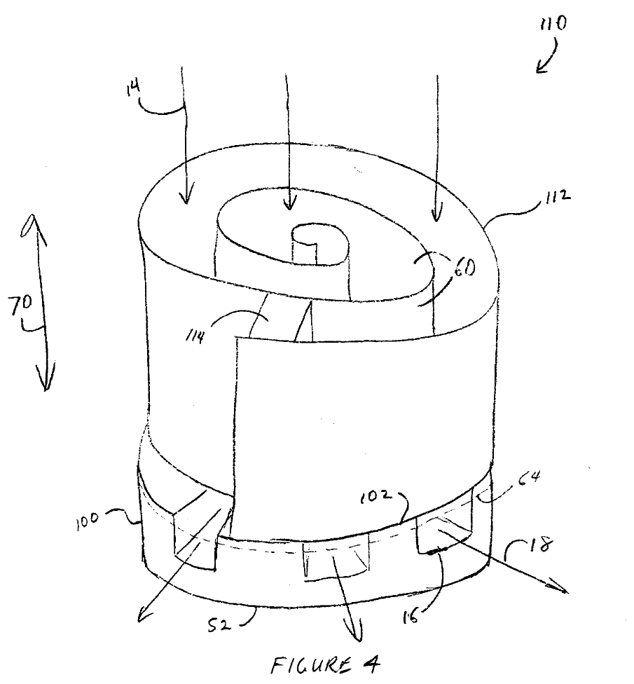

A third embodiment of the present invention is shown in FIG. 4, generally indicated by the reference number 110. Reactor 110 is a cylindrical embodiment of the present invention and is comprised of a coiled passage separation wall 112 that forms the reaction fluid channel and heat transfer medium. Coiled passage wall 112, as with passage separation wall 34 of the embodiment in FIG. 1, is also coated with catalyst 60. The coiled passage separation wall 112 is bonded to lands 102 on base plate/thermal interface 100 as shown in FIG. 4 using appropriate bonding methods as previously described. Base plate 100 is cylindrical and contains exit ports 16 defined by grooves provided in base plate 110 in fluid communication with the reaction fluid channel defined by coiled passage separation wall 112. Exit ports 16 can be provided about the entire circumference of base plate 110. Exit ports 16 can be alternatively provided by a base plate/thermal interface 100 without grooves attached to the coiled passage separation wall 112 having notches or holes near the bonded edge (not shown). In order to prevent the reacting fluid stream within the coiled channel from escaping the coil in a direction perpendicular to arrow 70, a seal arrangement 114 is provided to close the coil. Seal arrangement 114 can be a block of material that is bonded to and extends the flow length of coiled passage separation wall 112. Alternatively, seal arrangement 114 can be an adhesive layer that bonds the end of coiled passage separation wall 112 to itself at an intermediate length.

Operation and functionality of reactor 110 is similar to that described for reactors 10 and 80 of FIGS. 1 and 3, respectively, where reactants 14 enter the reactor, flow through the channels defined by coiled passage separation wall 112 and exit the reactor through exit channels 16 in the base plate 100. Heat of reaction flows in a direction generally parallel to arrow 70 and enters or exits the reactor 110 through thermal interface surface 52. This embodiment of the invention shares the advantages of previously described embodiments and is attended by the further advantage that the coiled design allows one to use a single strip of material, possibly catalytically active or pre-coated with particular catalyst 60, for the construction of reactor 110. The circular geometry also provides a possible advantage for connecting reactor 110 to round fluid inlet and outlet headers.

Operation of each embodiment in FIGS. 1-4 shares the common feature that a reacting fluid flows generally parallel to the direction of heat transfer 70 through the catalytically active channels and the fluid is redirected out of the device so that heat can be fed to or removed from the ends of the solid channel walls through a thermal interface surface 52. In its simplest form, the present invention may be thought of as two thermal assemblies that are generally separated by a dashed line 64 shown in FIGS. 1-4, wherein a heat of reaction is generated in one thermal assembly by a reacting fluid and the majority of that heat of reaction is transferred across thermal interface 52.

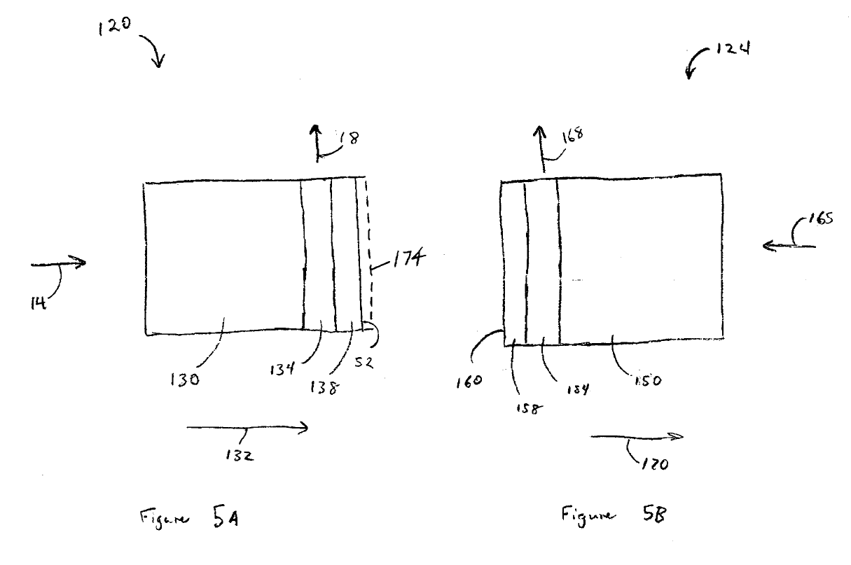

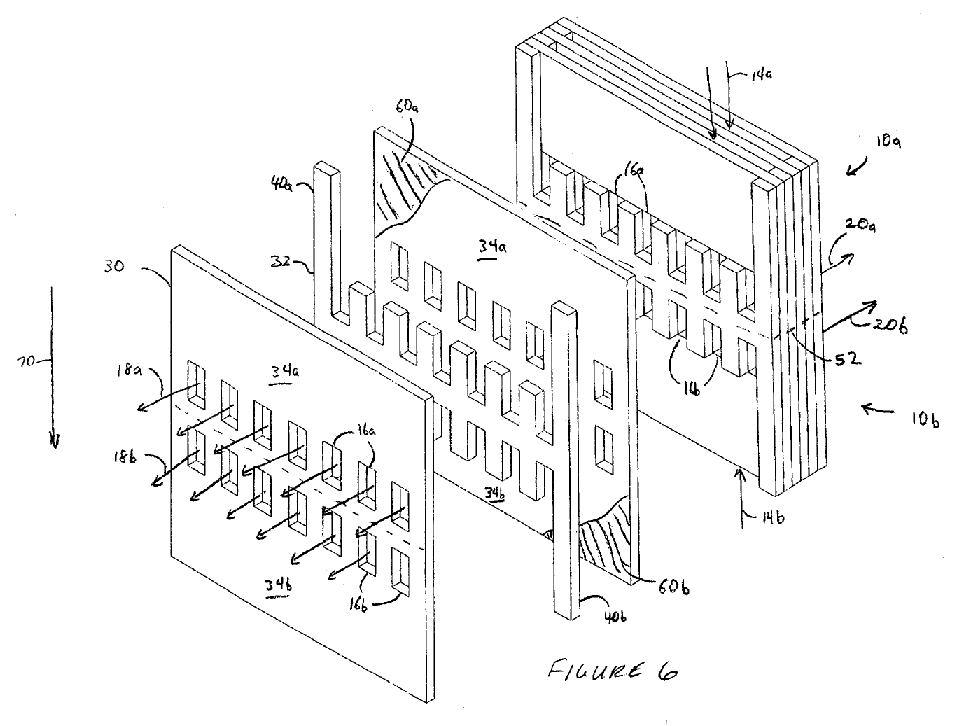

Such an arrangement is depicted in FIGS. 5a and 5b for a reactor 120 with exothermic reaction and a reactor 124 with endothermic reaction. Both reactors 120 and 124 may be represented by any embodiment of the present invention contemplated herein. For the exothermic reaction, the reactants are supplied in a direction generally defined by arrow 14 to a first catalytically active reaction zone 130. Within reaction zone 130, the reactant fluid reacts exothermically and the heat generated by the reaction is transferred to the channel walls and conducted within the walls in the direction of arrow 132. Reactant flow direction 14 and heat flow direction 132 are generally parallel within reaction zone 130. When the reactant and product mixture reaches the end of reaction zone 130, the fluid stream is redirected to exit the reactor by the exit ports located in the first exit zone 134. Reaction products leave the reactor in a direction generally not parallel with arrow 14, one direction of which is shown by arrow 18. A first solid heat transfer plate 138 provides an arrangement to prevent penetration of the reaction fluid and to conduct the majority of the heat generated by the reaction to heat transfer interface surface 52. Between reaction zone 130 and heat transfer plate 138, an arrangement for thermal communication is provided by contact or a thermally conductive path. Thermal interface surface 52 must be attached to a heat sink or allowed to radiate heat out of the reactor to maintain a temperature at or below a preferred value.

Still referring to FIGS. 5a and 5b, reactor 124, supporting the endothermic reaction, has a second reaction zone 150 containing a catalyst which may be different than the catalyst in first reaction zone 130. This mode of operation also contains an exit zone 154 and a heat transfer plate 158 with a thermal interface surface 160. In endothermic reaction, the reactants enter reactor 124 in a direction generally defined by arrow 165 and reaction products leave the reactor in a direction generally perpendicular to arrow 165, one direction of which is shown by an arrow 168. The heat of reaction is conducted through the walls of reaction zone 150 in an opposite but generally parallel direction to arrow 165 as shown by arrow 170. Thus, heat is provided to the endothernic reaction through the thermal interface surface 52 from an external heat source.

It is preferred that the length of reaction zone 130 be longer than exit zone 134 length in the direction of arrow 14. This ensures that most of the heat generated by the reaction conducts along the walls of the reaction zone, through the walls of the exit zone and into heat transfer plate 138. Heat transfer plate 138 may be of any thickness as to provide mechanical integrity and to be substantially impermeable to fluids but not overly thick as to limit heat transfer with an external process unless such a thermal limitation is desired. Note that reactors 10, 80, 110, 120, and 124 in FIGS. 1-5 were drawn with rectangular cross section, but the reactors are not required have this shape to retain the benefits of the present invention. Any reactor of the present invention can have non-uniform cross section in the heat transfer direction 70, and the general heat transfer direction 70 can be curved as in a curved reactor 10 as long as the fluid flow is generally parallel to the direction of heat flow 70 throughout most of the reactor 10. Furthermore, heat transfer plate 138 is not required to have uniform cross section in either heat flow direction 132 or in the direction perpendicular to the heat flow. Heat may be added to or removed from heat transfer plate 138 through thermal interface surface 52 in one or more directions not necessarily limited to a direction parallel with heat flow 132 in the reaction zone 130.

The thermal interface surface 52 of any embodiment of exothermic reactor 120 in FIG. 5a can be thermally connected with thermal interface surface 160 of any embodiment of endothermic reactor 124 in FIG. 5b as a method of supplying heat to an endothermic reaction from an exothermic reaction. Thermal interfaces 52 and 160 can be connected by any suitable thermal transfer arrangement such as conductive, convective, or radiative, but preferably by conductive contact in which thermal interfaces 52 and 160 are integrally formed or are bonded by bolting pressure, brazing, or any other appropriate method. In such an arrangement, at least a portion of the heat generated in reactor 120 is transferred to reactor 124 across thermal interfaces 52 and 160. Reactors 120 and 124 can be integrally formed such that the heat transfer plates 138 and 158 are defined by the same solid, as will be seen below with reference to FIG. 6. An example application of this configuration is the endothermic steam reforming of hydrocarbons coupled with exothermic combustion.

For thermally coupled endothermic and exothermic reactions that operate at substantially different temperatures, a region 174 of resistance to thermal conduction (shown using a dashed line in FIG. 5a) is added between thermal interfaces 52 and 160 of reactors 120 and 124, respectively. For a given heat flux through thermal interfaces 52 and 160, the temperature gradient between thermal interfaces 52 and 160 is higher when an increased thermal resistance is present between them. Therefore, the temperature difference between reactors 120 and 124 is greater for the same heat flux between them. The region of resistance to thermal conduction 174 can be any material with appropriate thermal conductivity and thickness to accommodate the desired temperature difference between reactors 120 and 124. Region 174 can also be integrally formed from the materials used in construction of reactors 120 and 124 where the conduction length of region 174 provides the resistance to heat transfer.

FIG. 6 shows a partially exploded view of integrally formed back to back reactor arrangements 10a and 10b wherein like components are indicated having an “a” or “b” appended, respectively, to like reference numbers of like components. Reactors 10a and 10b form a device for thermally coupling an exothermic reaction and an endothermic reaction. The catalytic exothermic reaction in reactor 10a takes place over catalyst 60a within channels 14a, and the heat thus generated is conducted along the passage walls 34a in a direction indicated by arrow 70. The exothermic products leave reactor 10a through exit ports 18a and 20a. The majority of the thermal energy produced from the exothermic reaction in reactor 10a is conducted through the thermal interface surface 52 and into reactor 10b where an endothermic reaction takes place. Reactor 10b contains a catalyst 60b which may be different in composition than that of catalyst 60a as required by the chosen endothermic reaction chemistry. Heat is conducted along channel walls 34b in a direction generally parallel to arrow 70. Products from the endothermic reaction exit reactor 10b through exit ports 16b. Using appropriate headers (not shown), reactants and products from each separate reactor can be kept separate, and the desired products from either reaction can be directed to a further process downstream. For instance, a mixture of air and fuel such as propane can be fed to reactor 10a through ports 14a, and combustion over a catalyst such as platinum dispersed on a high surface area washcoat on the walls 34a can produce heat to drive endothermic steam reforming in reactor 10b. Steam and propane can be feed through ports 14b into reactor 10b where a high surface area washcoat impregnated with nickel catalyst is supported on channel walls 34b. The flow rates of combustion reactants and steam reforming reactants fed to reactors 10a and 10b, respectively, are chosen to match the heats of reaction of both reactions. Another implementation of the coupled reactors 10a and 10b in FIG. 6 is to vaporize a liquid in reactor 10b using the heat from catalytic combustion in reactor 10a. Note that the temperatures between the two reactors 10a and 10b can be independently controlled by adjusting the conduction path length through the thermal interface surface 52 or by inserting a material with low thermal conductivity between reactors 10a and 10b at the thermal interface surface 52 as discussed for region 174 between reactors 120 and 124 in FIGS. 5a and 5b.

In an actual working embodiment of the present invention, hydrogen was burned with air over a platinum catalyst. The reactor was a double-sided device similar in design to that shown in FIG. 6, which shows a partially exploded view of the device. Each side of the double-sided reactor consisted of twenty-seven channels having a width of 30 mm and length of 10 mm with a 250-μm spacing. That is, a laminated structure using first and second alternating plates was used to create a system having a pair of integrally formed reactors sharing a common thermal interface 52 whereby channels on both sides were formed by alternately stacking 250 μm thick copper spacers and plates. Accordingly, these plates were identical to plate members 30 and 32 of FIG. 6 so as to define the pair of reactors. Exit channels and a thermally conductive path between each reactor side were integrally formed when the channel wall plates and spacers were stacked. The copper plates were diffusion bonded together in a vacuum furnace, and a thin nickel layer was applied to the channel surfaces by electroless deposition in order to improve the oxidation resistance of the structure. A high surface area alumina washcoat was applied to the channel walls by conventional sol-gel methods, and a platinum catalyst was applied by a standard wet impregnation technique. Headers were sealed with graphite gaskets to the inlets of both sides of the reactor core in order to feed hydrogen/air mixtures to the combustion side and air or water to the other side.

At room temperature, the platinum catalyst is active for the combustion of hydrogen, and a catalyst ignition heat source was not required. Due to safety concerns, the hydrogen/air ratio was kept at or below 0.1 (by volume). This mixture was fed to the catalytic side of the reactor at a rate that produced 860 W of thermal energy after complete combustion. Some of this heat was transferred to a room temperature air stream on the other side of the reactor. Both the combustion products and cooling air left the reactor at about 300° C. and 630 W of energy was transferred to the air stream. The corresponding heat flux between the two reactor halves was 1400 kW/M². The transient response of the reactor was also excellent, with a time constant of 30 seconds. This implementation of the reactor of the present invention is useful as a tail gas combustor in a fuel cell application where chemical energy in the fuel cell exhaust can be used for heating other components in the system such as, for example, a fuel vaporizer, steam reformer, or air preheater.

A comparison between the present invention and a reactor with hydrogen combustion transferring heat to a cooling fluid flowing parallel to but on opposite sides of a heat exchange plate demonstrates the dramatic and unexpected improvements that are available through the practice of the present invention. A prior art combustor-vaporizer (Tonkovich, A. Y., S. P. Fitzgerald, J. L. Zilka, M. J. LaMont, Y. Wang, D. P. VanderWiel, R. S. Wegeng, “Microchannel Chemical Reactors for Fuel Processing Applications. II. Compact Fuel Vaporization.” Presented at the 3rd International Conference on Microreaction Technology, Frankfurt, Germany, April, 1999) is considered the state-of the-art microchannel reactor technology. The experimental conditions used herein are very similar to those reported for the prior art combustor-vaporizer, which also burned hydrogen (at about 5.6% in air) and exhausted combustion gas and fuel vapor at temperatures ranging between about 250 and 350° C. The prior art reactor used microchannels to enhance heat transfer between catalytic combustion and vaporization in a parallel flow channel configuration. Although the hydrogen concentration in the combustion feed was about a factor of two greater in the tests of the present invention, the present invention exhibited order-of-magnitude improvements over the prior art reactor. On a power density basis, the NFR of the present invention is 14 times smaller and 21 times lighter than the prior art reactor with the same output. It should be appreciated that this level of improvement or better is considered to be readily achievable. The measured power densities in the NFR were limited only by safety and material thermal and oxidation resistance. Higher hydrogen concentration in the feed would lead to higher power density, but with increased danger of homogeneous ignition of the mixture before entering the reactor. Furthermore, higher power densities lead to higher temperatures within the reactor for which the upper limit is set by the thermal stability of the catalyst and reactor materials. The use of higher temperature materials is contemplated to allow combustion of safer fuels like propane above 500° C. Since catalytic combustion at these temperatures is limited by mass transfer, hydrocarbon combustion should exhibit similar or better results than those demonstrated with hydrogen combustion at low temperature.

In another demonstration of the device, water was fed to the cooling side of the device and 1.1 kW (2500 kW/m²) of thermal energy was transferred to the water to make steam.

In view of the described experimental results, as compared with prior art standards, it is readily apparent that the reactor of the present invention provides sweeping advantages over the prior art, thereby providing a new standard of performance which was heretofore unattainable in compact chemical reactors. Having brought the present invention to light, Applicants expect its performance advantages to enjoy application at least in steam reforming of hydrocarbons to make hydrogen, production of useful heat from catalytic combustion of fuels, temperature control of exothermic reactions like the partial oxidation of ethylene to produce ethylene oxide, and other reactions where the heat of reaction is high enough to exploit the heat transfer benefits of present invention.

Having described the present invention in detail above, as well as its unprecedented performance advantages, it is worthwhile to now draw some further comparisons with the prior art. As described above, the present invention recognizes that coupled exothermic and endothermic reactions in alternating parallel plate microchannel reactors, where the two reaction streams flow parallel to and on opposite sides of a heat transfer plate, are inherently problematic. First, the prior art has been unable to provide a uniform reaction along the direction of flow, resulting in uneven temperature gradients which generally adversely affect one or both reactions. The reactor of the present invention, in contrast, is considered to have resolved this problem. Stated in a slightly different way, the present invention provides, from a practical standpoint, a thermal flux across the thermal interface of the reactor, as shown by dotted line 52 in FIG. 6, which is constant per unit area of the interface. Second, a preferred temperature difference between two reactions cannot be significantly different, in a prior art parallel flow configuration, unless insulation is added to each and every heat transfer plate in the reactor. In the present invention, only one insulation layer or thermal resistance configuration, in the case of an integrally formed reactor system, is required for thermal matching purposes between the two reactor sides to provide for desired temperature differences between two thermally coupled reactions.

Referring generally to FIG. 6, it should be appreciated that the present invention contemplates a wide range of back-to-back configurations wherein any suitable combination of reactor embodiments described herein may be used. Further, it is important to understand that reactors having different thermal interface surface areas may be thermally coupled in any suitable manner. Not only may the surface areas be different, but the thermal coupling arrangement may serve to change the direction of heat flow, such that heat flow is not necessarily parallel in one reactor to the heat flow in the reactor to which it is thermally coupled. Nonetheless, an essentially constant thermal flux is provided through the end thermal interfaces of such thermally coupled reactors. Thermal coupling may further serve to match the reaction in one reactor to the reactor with which it is coupled. For example, one or more thermal isolation layers may be introduced in the thermal coupling arrangement for supporting a particular thermal gradient, as part of this thermal process matching.

Although each of the aforedescribed physical embodiments have been illustrated with various components having particular respective orientations, it should be understood that the present invention may take on a variety of specific configurations with the various components being located in a wide variety of positions and mutual orientations. Furthermore, the methods described herein may be modified in an unlimited number of ways, for example, by reordering, modifying and recombining the various steps. Accordingly, it should be apparent that the arrangements and associated methods disclosed herein may be provided in a variety of different configurations and modified in an unlimited number of different ways, and that the present invention may be embodied in many other specific forms without departing from the spirit or scope of the invention. Therefore, the present examples and methods are to be considered as illustrative and not restrictive, and the invention is not to be limited to the details given herein, but may be modified within the scope of the appended claims.

What is claimed is:

1. An assembly for use in performing a chemical reaction that is characterized by a heat of reaction, said assembly comprising:
first thermally conductive means defining at least one catalytically active flow passage for conducting a fluid at least generally in a predetermined direction while catalytically activating said chemical reaction with said fluid in a way which produces said heat of reaction and said heat of reaction conducts primarily through said first thermally conductive means in a direction at least generally parallel with said predetermined direction; and
second thermally conductive means in thermal communication with said first thermally conductive means and configured for transferring said heat of reaction to an external process and for redirecting the fluid received from said first thermally conductive means to a different direction as compared to said predetermined direction.

2. The assembly of claim 1 wherein said first thermally conductive means defines a plurality of said catalytically active flow passages that are at least generally parallel for conducting said fluid in said predetermined direction.

3. The assembly of claim 1 wherein said first thermally conductive means is formed using a coiled strip in a way which provides a channel in which said fluid flows in said predetermined direction, thereby producing said heat of reaction.

4. The assembly of claim 1 wherein said first thermally conductive means is formed using a porous material having a plurality of pores through which said fluid flows and a substantial portion of said heat of reaction conducts through said porous material.

5. The assembly of claim 4 wherein said porous material is catalytically active.

6. The assembly of claim 4 wherein said porous material is treated with a catalytically active material.

7. The assembly of claim 1 wherein at least said first thermally conductive means is formed entirely from a catalytic material serving to catalytically activate said heat of reaction and for defining said flow passage.

8. The assembly of claim 1 wherein at least said catalytically active flow passage of said first thermally conductive means is defined by an interior wall arrangement having a surface area and said surface area supports a catalytic material for catalytically activating the flow passage.

9. The assembly of claim 1 wherein at least said catalytically active flow passage of said first thermally conductive means is defined by an interior wall arrangement forming an interior volume and said interior volume contains a catalytic material that is captured within said interior wall arrangement.

10. The assembly of claim 1 wherein said second thermally conductive means is configured for providing an at least approximately constant thermal flux per unit area therethrough in said direction that is at least generally parallel to the predetermined direction.

11. The assembly of claim 1 wherein said first thermally conductive means defines a plurality of said catalytically active flow passages that is formed by an interior wall arrangement having a surface area, and said surface area is sized based on certain process characteristics of said chemical reaction including said heat of reaction.

12. The assembly of claim 11 wherein said each flow passage of said first thermally conductive means includes a length at least generally along said predetermined direction such that the surface area is sized based, at least in part, on said length.

13. The assembly of claim 11 wherein said first thermally conductive means includes a peripheral outline such that said surface area is sized based, at least in part, on modifying the peripheral outline.

14. The assembly of claim 1 wherein said first thermally conductive means includes a peripheral outline and an interior wall arrangement forming a wetted perimeter, and said peripheral outline is sized to modify said wetted perimeter.

15. The assembly of claim 1 wherein said first thermally conductive means and said second thermally conductive means are integrally formed as portions of an overall laminated thermally conductive body.

16. The assembly of claim 15 wherein said overall laminated thermally conductive body includes an alternating series of first and second plate members, each of which plate members is integrally formed, stacked in thermal communication such that the first and second plate members cooperate to define
a plurality of said catalytically active flow passages formed between adjacent ones of the first plate members, in said alternating series, which are held in a spaced apart, confronting relationship by one of the second plate members, said passages having an outermost passage opening for use in forming a first external flow connection with said assembly and having an innermost, opposing passage end that is bounded by the second plate member,
at least one exit channel extending transversely through said alternating series of plate members in flow communication with said passage ends and extending to an outermost, end one of the plate members to define an external channel opening in the end one of the plate members for use in forming a second external flow connection with said assembly, and
a laminated thermal header arrangement formed by adjacent end portions of the first and second plate members which at least partially serve to define said exit channel and which further cooperate to define an external thermal interface surface of said assembly for providing external thermal communication.

17. The assembly of claim 16 configured for defining a plurality of said exit channels in a spaced apart, at least generally parallel relationship.

18. The assembly of claim 16 wherein said exit channel includes a length extending through a an overall stacked thickness of the alternating series of said plate members and terminating in opposing first and second ones of outermost channel ends having a first and a second external channel opening, respectively, and said assembly further includes means for sealing a selected one of the first and second opposing channel openings.

19. The assembly of claim 16 wherein said sealing means includes a sealing plate that is attached to an end one of said first and second plate members.

20. The assembly of claim 16 wherein said exit channel is at least generally normal to each of said first and second plate members.

21. The assembly of claim 16 wherein the predetermined direction of fluid flow through said passages is at least generally parallel to heat flow through said first and second plate members.

22. The assembly of claim 16 wherein an additional pair of plate members including an additional first plate member and an additional second plate member, as part of said layered configuration, extend the alternating series of plate members to define an additional passage including an additional outermost passage opening for use in forming said first external flow connection with said assembly and an additional innermost, opposing passage end that is bounded by the additional second plate member and further cooperatively extending said exit channel transversely through the additional first and additional second plate members, in flow communication with the catalytically active passages and with the additional passage, and said additional second plate member serving as the end plate member so as to define said external channel opening and said additional first and second plate members including additional adjacent end portions which at least partially serve to define said exit channel and which further cooperate to extend said external thermal interface surface.

23. The assembly of claim 22 including one or more further additional pairs of the first and second integrally formed plate members, within said layered configuration, each of which further additional pairs cooperates in the series of plate members to define a further additional passage including a further additional outermost passage opening for use in forming said first external connection with said assembly and a further additional innermost, opposing end bounded, at least in part, by the second plate member of each further additional pair of first and second plate members and further cooperatively extending said exit channel transversely through the further additional first and second plate members in flow communication with each further additional passage.

24. The assembly of claim 1 wherein said first thermally conductive means and said second thermally conductive means are integrally formed.

25. The assembly of claim 1 wherein said first thermally conductive means and said second thermally conductive means are separately formed and thermally interfaced in a way which provides said thermal communication.

26. A system for thermally coupling an exothermic reaction with an endothermic reaction, said system comprising:
a first assembly according to claim 1 for supporting said exothermic reaction having a first heat of reaction; and
a second assembly according to claim 1 for supporting said endothermic reaction and having a second heat of reaction, and said second thermally conductive means of said second assembly arranged in thermal communication with said second thermally conductive means of said first assembly for thermally coupling said first heat of reaction with said second heat of reaction.

27. In producing an assembly for use in performing a chemical reaction having a heat of reaction, a method comprising the steps of:
defining at least one portion of a first thermally conductive means with at least one flow passage for conducting a fluid at least generally in a predetermined direction while catalytically activating said chemical reaction with said fluid in a way which produces said heat of reaction; and
arranging second thermally conductive means in thermal communication with said first thermally conductive means for conducting said heat of reaction through said first thermally conductive means in a heat transfer direction that is at least generally parallel with said predetermined direction and for redirecting the fluid received from said first thermally conductive means to a different direction as compared to said predetermined direction.

28. The method of claim 27 including the step of defining a plurality of said flow passages, each of which is catalytically active in said first thermally conductive means, that are at least generally parallel for conducting said fluid in said predetermined direction.

29. The method of claim 27 including the step of defining said catalytically active flow passage using a coiled strip in a way which provides a channel in which said fluid flows in said predetermined direction, thereby producing said heat of reaction.

30. The method of claim 27 including the step of defining a plurality of said catalytically active flow passages using a porous material in a way which provides a plurality of pores through which said fluid flows and a substantial portion of said heat of reaction conducts through the porous material.

31. The method of claim 30 wherein said porous material is selected as a catalytically active material.

32. The method of claim 30 including the step of treating said porous material with a catalytically active material.

33. The method of claim 27 including the step of forming said first thermally conductive means entirely from a catalytic material, serving to catalytically activate said heat of reaction and for defining the first passage arrangement.

34. The method of claim 27 including the step of defining at least said catalytically active flow passage of said first thermally conductive means using an interior wall arrangement having a surface area and said surface area supports a catalytic material for catalytically activating the flow passage.

35. The method of claim 27 wherein at least said catalytically active flow passage of said first thermally conductive means is defined by an interior wall arrangement forming an interior volume and including the step of capturing a catalytic material in said interior volume within said interior wall arrangement.

36. The method of claim 27 including the step of configuring said second thermally conductive means for providing an at least approximately constant thermal flux per unit area therethrough in said direction that is at least generally parallel to the predetermined direction.

37. The method of claim 27 including the steps of defining a plurality of said catalytically active flow passages using an interior wall arrangement having a surface area and sizing said surface area based on certain process characteristics of said chemical reaction including said heat of reaction.

38. The method of claim 37 wherein said each flow passage of said first thermally conductive means includes a length at least generally along said predetermined direction such that the surface area is sized based, at least in part, on said length.

39. The method of claim 37 wherein said first thermally conductive means includes a peripheral outline such that said surface area is sized based, at least in part, on modifying the peripheral outline.

40. The method of claim 27 wherein said first thermally conductive means includes a peripheral outline and an interior wall arrangement forming a wetted perimeter, and including the step of sizing said peripheral outline to modify said wetted perimeter.

41. The method of claim 27 including the step of integrally forming said first thermally conductive means and said second thermally conductive means as portions of an overall laminated thermally conductive body.

42. The method of claim 41 wherein the step of integrally forming the overall laminated thermally conductive body includes the steps of stacking an alternating series of first and second plate members, each of which plate members is integrally formed, stacked in thermal communication such that the first and second plate members cooperate to define
a plurality of said catalytically active flow passages formed between adjacent ones of the first plate members, in said alternating series, which are held in a spaced apart, confronting relationship by one of the second plate members, said passages having an outermost passage opening for use in forming a first external flow connection with said assembly and having an innermost, opposing passage end that is bounded by the second plate member,
at least one exit channel extending transversely through said alternating series of plate members in flow communication with said passage ends and extending to an outermost, end one of the plate members to define an external channel opening in the end one of the plate members for use in forming a second external flow connection with said assembly, and
a laminated thermal header arrangement formed by adjacent end portions of the first and second plate members which at least partially serve to define said exit channel and which further cooperate to define an external thermal interface surface of said assembly for providing external thermal communication.

43. The method of claim 27 including the step of integrally forming said first thermally conductive means and said second thermally conductive means.

44. The method of claim 27 including the steps of separately forming said first thermally conductive means and said second thermally conductive means and interfacing said first thermally conductive means and said second thermally conductive means in a way which provides said thermal communication.

45. In producing a system for thermally coupling an exothermic reaction with an endothermic reaction, a method comprising the steps of:
forming a first assembly according to claim 27 for supporting said exothermic reaction having a first heat of reaction;
forming a second assembly according to claim 27 for supporting said endothermic reaction having a second heat of reaction; and
arranging said second thermally conductive means of said second assembly in thermal communication with said second thermally conductive means of said first assembly for thermally coupling said first heat of reaction with said second heat of reaction.

46. A compact chemical reactor, comprising:
thermally conductive means including a first portion for defining one or more catalytically active channels through which a reaction fluid flows and which cooperate to at least generally define a flow direction of said reaction fluid therethrough, thereby producing a heat of reaction, and a second portion for defining at least one exit channel in fluid communication with said catalytically active channels and for further defining a heat transfer surface, in thermal communication with said first portion defining the catalytically active channels, in a way which serves to redirect flow of the reaction fluid from the catalytically active channels into the exit channel such that a direction in which the heat of reaction conducts through said first portion is at least generally parallel to said flow direction and a substantial portion of said heat of reaction passes through said heat transfer surface.

47. The compact chemical reactor of claim 46 wherein a direction of fluid flow within the catalytic reaction path is at least generally normal to the exit portion of the fluid path.

48. The compact chemical reactor of claim 46 wherein said first portion includes a porous material defining a plurality of pores such that said reaction fluid flows through the pores and said heat of reaction conducts primarily within the pore defining structure of the porous material.

49. The compact chemical reactor of claim 46 wherein said first portion is a catalytically active material.

50. The compact chemical reactor of claim 46 wherein said catalytically active channels are defined by an interior surface that is treated with a catalytically active material.

51. The compact chemical reactor of claim 46 wherein said first portion includes an interior wall arrangement forming an interior volume for defining said catalytically active channels and said interior volume contains a catalytic material that is captured within said interior wall arrangement.

52. The compact chemical reactor of claim 46 wherein said first portion includes a coiled strip for defining at least one of said channels in which said reaction fluid flows.

53. The compact chemical reactor of claim 46 wherein said first portion and said second portion of the thermally conductive means are separately formed and interfaced in a way which provides thermal communication therebetween.

54. A method for producing a compact chemical reactor within an overall thermally conductive arrangement, said method comprising the steps of:
forming thermally conductive means including a first portion for defining one or more catalytically active channels through which a reaction fluid is to flow and which channels cooperate to at least generally define a flow direction of said reaction fluid therethrough, thereby producing a heat of reaction and a second portion for defining at least one exit channel in fluid communication with said plurality of catalytically active channels, and said second portion further defining a heat transfer surface such that said flow direction is at least generally parallel with a direction in which the heat of reaction conducts through said first portion and at least a substantial portion of the heat of reaction passes through said heat transfer surface and external to the compact chemical reactor.

55. The method of claim 54 including the step of integrally forming said first portion and said second portion of the thermally conductive means as parts of an overall laminated thermally conductive body.

56. The method of claim 54 including the step of integrally forming said first portion and said second portion of the thermally conductive means.

57. The method of claim 54 including the steps of separately forming said first portion and said second portion of the thermally conductive means and thermally interfacing the first and second portions.

58. The method of claim 54 including the step of defining a plurality of said catalytically active flow channels using a porous material defining a plurality of pores through which said fluid flows and the said heat of reaction conducts primarily through said porous material.

59. The method of claim 54 wherein said first portion is selected as a catalytically active material.

60. The method of claim 54 wherein said catalytically active channels are defined by an interior surface and including the step of treating said interior surface with a catalytically active material.

61. The method of claim 54 wherein said first portion includes an interior wall arrangement forming an interior volume for defining said catalytically active channels and including the step of capturing a catalytic material within said interior volume using said interior wall arrangement.

62. The method of claim 54 including the step of using a coiled strip in a way which provides at least one of said catalytically active channels in which said fluid flows in said predetermined direction, thereby producing said heat of reaction.

63. A method for transferring heat responsive to a chemical reaction in a compact chemical reactor within an overall thermally conductive structure, said method comprising the steps of:
forming a plurality of catalytically active channels, as a first portion of said overall thermally conductive structure, through which a reaction fluid is to flow, thereby producing a heat of reaction;
defining at least one exit channel in fluid communication with said plurality of catalytically active channels; and
configuring a heat transfer surface, as a second portion of said overall thermally conductive means, for redirecting flow of the reaction fluid from the catalytically active channels across the heat transfer surface and, thereafter, into the exit channel such that at least a substantial portion of the heat of reaction is conducted along said first portion of the thermally conductive structure and through said heat transfer surface.

64. The method of claim 63 wherein said plurality of catalytically active channels define a flow direction of said fluid that is at least generally parallel with conduction of said heat of reaction through said first portion of said overall thermally conductive structure.

65. A system for transferring a heat of reaction between first and second processes that are performed within the system, said system comprising:
first thermally conductive means for executing said first process and configured for receiving a first flow of a first fluid through a first passage arrangement such that an overall flow of the first fluid includes a first directional orientation that is directed toward a first internal surface of a first thermal interface member, formed by the first thermally conductive means, and said first thermally conductive means is further configured for directing said first fluid outwardly therefrom and away from said first directional orientation across said first internal surface;
second thermally conductive means for executing said second process and configured for receiving a second flow of a second fluid through a second passage arrangement such that the overall flow of the second fluid includes a second directional orientation that is directed toward a second internal surface of a second thermal interface member, formed by the second thermally conductive means, and said second thermally conductive means is further configured for directing said second fluid away from said second directional orientation across said second internal surface, said second thermal interface member being arranged in thermal communication with said first thermal interface member such that said first and second processes are thermally coupled between said first and second thermal interface members; and
at least one of said first and second thermally conductive means including a configuration for catalytically activating at least a selected one of the first passage arrangement and the second passage arrangement so as to produce said heat of reaction for thermal coupling through said first and second thermal interface members.

66. The system of claim 65 wherein said heat of reaction conducts primarily along said first thermally conductive means in a direction at least generally parallel with said first directional orientation.

67. The system of claim 65 wherein said heat of reaction conducts primarily along said second thermally conductive means in a direction at least generally parallel with said second directional orientation.

68. The system of claim 65 wherein said first passage arrangement defines a first plurality of channels that are at least generally parallel and said second passage arrangement defines a second plurality of channels that are at least generally parallel.

69. The system of claim 65 wherein said catalytic reaction is endothermic.

70. The system of claim 65 wherein said catalytic reaction is exothermic.

71. The system of claim 69 wherein said catalytic reaction is steam reforming.

72. The system of claim 71 wherein hydrogen gas is produced by steam reforming.

73. The system of claim 71 wherein the second passage arrangement of said second thermally conductive means includes an additional catalyst such that the second thermally conductive means activates a catalytic combustion of said second fluid to produce said heat of reaction traveling from said second thermally conductive means to said first thermally conductive means for use in said steam reforming.

74. The system of claim 65 wherein said first thermally conductive means includes said configuration for catalytically activating an exothermic reaction with said first fluid and said second thermally conductive means includes an additional configuration for catalytically activating an endothermic reaction with said second fluid.

75. The system of claim 65 wherein said heat of reaction is thermally balanced by a phase change of said second fluid in said second thermally conductive means.

76. The system of claim 65 wherein said first and second thermal interface members support said first and second internal surfaces in a spaced apart, at least approximately parallel relationship.

77. The system of claim 65 wherein said first and second thermally conductive means are integrally formed as portions of an overall thermally conductive body.

78. The system of claim 65 wherein said first and second thermally conductive means are individually formed and thermally connected at said first and second thermal interface members.

79. The system of claim 65 wherein at least said first passage arrangement of the first thermally conductive arrangement includes a porous material defining a plurality of pores through which said fluid flows and the heat of reaction conducts primarily through said porous material.

80. The system of claim 65 wherein said first thermally conductive means is a catalytically active material.

81. The system of claim 65 wherein said configuration for activating at least one of the first passage arrangement and the second passage arrangement includes a catalytically active material applied to one or more inner surfaces defining at least one of the first and second passage arrangement.

82. The system of claim 65 wherein said first passage arrangement and said second passage arrangement define an interior volume and wherein said configuration for catalytically activating at least one of the first passage arrangement and the second passage arrangement includes a catalytic material that is captured within the catalytically activated ones of the first and second passage arrangements.

83. The system of claim 79 wherein said second passage arrangement of said second thermally conductive means is defined by an interior plate arrangement forming a plurality of at least generally parallel channels along said second directional orientation towards said second internal surface.

84. The system of claim 65 wherein at least said first thermally conductive means is formed entirely from a catalytic material serving as said configuration for catalytically activating and for defining the first passage arrangement.

85. The system of claim 65 wherein at least said first passage arrangement of said first thermally conductive means is defined by an interior wall arrangement having a surface area and said surface area supports a catalytic material for catalytically activating the first passage.

86. The system of claim 65 wherein at least said first passage arrangement of said first thermally conductive means is defined by an interior wall arrangement forming an interior volume and said interior volume contains a catalytic material that is captured within said interior wall arrangement.

87. The system of claim 65 wherein said first and second thermally conductive means are configured for providing an at least approximately constant thermal flux per unit area through said first and second thermal interface members.

88. The system of claim 65 wherein said first passage arrangement of the first thermally conductive means is formed by a first interior wall arrangement defining a first plurality of at least generally parallel channels having a first surface area and said second passage arrangement of the second thermally conductive means is formed by a second interior wall arrangement defining a second plurality of at least generally parallel channels having a second surface area and said first and second surface areas are sized based on certain process characteristics of said first and second processes along with said heat of reaction.

89. The system of claim 88 wherein said first and second channels of said first and second thermally conductive means include a first length at least generally along said first directional orientation and a second length at least generally along said second directional orientation, respectively, such that the first surface area and the second surface area are sized based, at least in part, on said first length and said second length.

90. The system of claim 88 wherein said first thermally conductive means and said second thermally conductive means include a first peripheral outline and a second peripheral outline, respectively, such that said first surface area and the second surface area are sized based, at least in part, on modifying the first peripheral outline and the second peripheral outline.

90. The system of claim 64 wherein said first thermally conductive means and said second thermally conductive means include a first peripheral outline and a second peripheral outline, respectively, and said configuration for catalytically activating at least a selected one of the first passage arrangement and the second passage arrangement forms a wetted perimeter such that the peripheral outline of the selected passage arrangement is sized to modify the wetted perimeter.

91. The system of claim 64 further comprising:
thermal coupling means for providing said thermal communication and to thermally couple said heat of reaction between the first thermal interface member and the second thermal interface member in a way which establishes a selected value of thermal conductance between the first thermally conductive means and the second thermally conductive means that permits said first process to operate at a first preferred temperature, at said first internal surface of the first thermal interface member, and that permits said second process to operate at a second preferred temperature, at said second internal interface of the second thermal interface member.
